(19) United States
(12) Patent Application Publication
(10) Pub. No.: US 2009/0187833 A1
(43) Pub. Date: Jul. 23, 2009

(54) DEPLOYING A VIRTUAL WORLD WITHIN A PRODUCTIVITY APPLICATION

(75) Inventors: Li-Te Cheng, Malden, MA (US); John F. Patterson, Carlisle, MA (US); Steven L. Rohall, Winchester, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/017,017

(22) Filed: Jan. 19, 2008

(51) Int. Cl. G06F 3/048; G06F 15/16

(52) U.S. Cl. 715/757

(57) ABSTRACT

Embodiments of the present invention address deficiencies of the art in respect to virtual world management and provide a method, system and computer program product for deploying a virtual world within a productivity application. In an embodiment of the invention, a productivity application can be provided to include each of a document editor, a virtual world client configured to provide a view to a virtual world, presence awareness producing a presence state for an end user of the editor, and an integrator configured to provide a presence state detected by the presence awareness to the virtual world viewed through the virtual world client. For example, the productivity application can be an IDE for source code development.

### BACKGROUND OF THE INVENTION

1. Field of the Invention

The present invention relates to virtual reality and more particularly to virtual world management over a computer communications network.

2. Description of the Related Art

As the progenitor to the modern virtual world, the multi-user dungeon provided a revolutionary experience for its first participants more than three decades ago. The multi-user dungeon was and continues to be a multi-player computer game that combines elements of role-playing, first person shooter and social chat. The multi-user dungeon generally executes in a central server configured for simultaneous access by participants over a global computer communications network like the Internet. The multi-user dungeon historically has been text-driven where the immediate environment is presented to participants in text form, and participants engage in actions in the environment through textual directives mimicking the postings of an instant messenger. Non-player characters in the multi-user dungeon can be automated and the actions of the non-player characters can be broadcast to the participants also as textual postings.

Like a multi-user dungeon, virtual reality allows a user to interact with a computer-simulated environment; however in virtual reality, the virtual environment is visual in nature and can be displayed either on a computer screen or through customized or stereoscopic displays. Advanced modes of virtual reality further incorporate other sensory presentation elements, including audio elements and tactile elements. Generally, end-users interact with a virtual reality environment through traditional keyboard and mouse movements, though other input means are provided occasionally including gyroscopic handheld devices and gloves, and joysticks. Consistent throughout all virtual reality experiences, the virtual reality environment reflects the real world environment and has proven invaluable in commercial applications such as flight simulation or combat training.

The virtual world builds upon the multi-user dungeon and virtual reality in order to provide a computer-based simulated environment in which participants interact with one another through three-dimensional visually displayable surrogates referred to as avatars. In this regard, participants “inhabit” the virtual world through their respective avatars. In as much as avatars can freely roam the bounds of the virtual world, virtual worlds expand the boundaries of the multi-user dungeon and permit participants to truly enjoy freedom of motion and exploration within the virtual world. To date, virtual worlds have become such close approximations to reality that the lines of reality have become blurred to the extent that many participants treat ordinary interactions in the virtual world with the same degree of seriousness as those same interactions in the real world.

Presently, virtual world implementations provide for a centralized server or centralized arrangement of servers hosting the logic necessary to create and manage a virtual world, while end users interacting with the virtual world do so through remotely coupled clients. While a content browser interface can be used to support the virtual world interface, advanced forms of the virtual world implementation provide a heavy client for each end user accessing the virtual world. In either circumstance, however, a separate, stand-alone application is required exclusively to provide access to the end user to the virtual world. Still, as the use of the modern virtual world has been limited to socializing and gaming, the limitation of access to the virtual through a stand-alone client has been of no consequence.

The corporate computing environment differs substantially from the home computing environment used solely for gaming and socializing. In the home computing environment, social interactions occur with intent as the end user expressly loads and nearly exclusively focuses on an active virtual world in which the end user interacts. In the corporate environment, however, social interactions occur by chance in the interim gaps of time between bursts of work. Modeled in reality by the corporate water cooler, corporate computing users operate in a “heads down” mode while engaging in computing through one or more productivity applications, and in a “heads up” mode from time to time as the end user disengages from a productivity application to meet with someone else, to grab a cup of coffee, to retrieve a document from a printer, to surf the Web, answer and e-mail and so forth.

### BRIEF SUMMARY OF THE INVENTION

Embodiments of the present invention address deficiencies of the art in respect to virtual world management and provide a novel and non-obvious method, system and computer program product for deploying a virtual world within a productivity application. In an embodiment of the invention, a productivity application can be provided to include each of a document editor, a virtual world client configured to provide a view to a virtual world, presence awareness producing a presence state for an end user of the editor, and an integrator configured to provide a presence state detected by the presence awareness to the virtual world viewed through the virtual world client. For example, the productivity application can be an IDE for source code development.

In another embodiment of the invention, a method for deploying a virtual world within a productivity application can be provided. The method can include logging an end user of a productivity application into a virtual world, detecting a presence state of the end user of the productivity application, providing the presence state to the virtual world for reflection in connection with an avatar for the end user in the virtual world, and rendering a view of document editor and also a view to the virtual world in a user interface for the productivity application. In one aspect of the embodiment, providing the presence state to the virtual world for reflection in connection with an avatar for the end user in the virtual world can include visually indicating the presence state in connection with the avatar in a word balloon displayed in proximity to the avatar in the virtual world or in a pose of the avatar in the virtual world.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for deploying a virtual world within a productivity application;

FIG. 2 is a pictorial illustration of a user interface for a productivity application incorporating a view to a virtual world;

FIG. 3 is a schematic illustration of a virtual world data processing system configured for deploying a virtual world within a productivity application; and,

FIG. 4 is a flow chart illustrating a process for deploying a virtual world within a productivity application.

### DETAILED DESCRIPTION OF THE INVENTION

Embodiments of the present invention provide a method, system and computer program product for deploying a virtual world within a productivity application. In accordance with an embodiment of the invention, a view to a virtual world can be disposed within a productivity application. In particular, the productivity application can support a document editor and can be by way of example, an integrated development environment (IDE) for the development of program code. Presence awareness can monitor the state of an end user utilizing the productivity application and the state can be provided in association with an avatar for the end user in the virtual world. In this way, a corporate user of a productivity application can enjoy the benefit of the virtual world without expressly activating a separate virtual world client application.

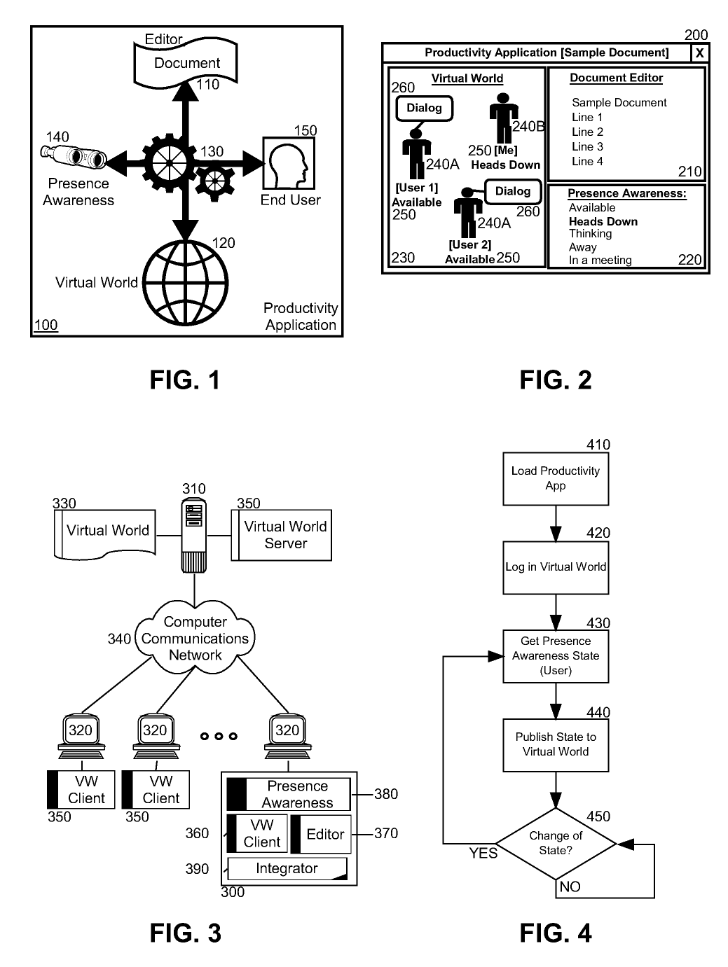

In further illustration, FIG. 1 is a pictorial illustration of a process for deploying a virtual world within a productivity application. As shown in FIG. 1, a document editor 110 and a view to a virtual world 120 can be incorporated into a single productivity application 100, for example a word processor, spreadsheet, database management system, image editor, collaborative computing client, or IDE for software development. Presence awareness 140 further can be included in the productivity application in order to automatically determine a presence state of an end user 150 utilizing the productivity application 100, or to accept a manual specification by the end user 150 of a presence state.

An integrator 130 can be provided in the productivity application 100. The integrator 130 can provide a presence state detected by presence awareness 140 in the productivity application 100 to the view to the virtual world 120. In this regard, the presence state can be reflected in association with an avatar for the end user 150 in the view to the virtual world 120 and to others in the virtual world 120. For instance, the presence state can be reflected by a pose of the avatar, or by a graphical or textual indicator rendered in proximity to the avatar for the end user 150.

In further illustration, FIG. 2 shows an exemplary user interface 200 for a productivity application incorporating a view to a virtual world. The user interface 200 can include each of an editor 210, presence awareness 220 and a virtual world view 230. The editor 210 can be configured to edit a document, for example a word processing document, a spreadsheet, an image, a database, or source code, to name only a few examples. The presence awareness 220 in turn can provide an indication of a current presence state and can be configured to permit a selection of other presence states, or can be configured to automatically detect a presence state based upon the activities of the end user.

The virtual world view 230 can provide a view to a remotely established virtual world including different avatars 240A, 240B for different participants to the virtual world. Interactions between the avatars 240A, 240B in a location in the virtual world can be reflected in associated objects such as word balloons 260 placed in proximity to respective ones of the avatars 240A, 240B. In this way, a conversation between avatars 240A, 240B can be recognized by one present in the location in the virtual world irrespective of a degree of participation in the conversation. Finally, a presence state 250 for each end user corresponding to one of the avatars 240A, 240B in the location in the virtual world can be provided in connection with a respective one of the avatars 240A, 240B.

Notably, in consequence of the arrangement shown in FIG. 2, an end user interacting with a productivity application providing the user interface 200 can remain in a heads down mode while remaining engaged in a location in the virtual world. Other end users engaged in the location in the virtual world can recognize the presence state of heads down for the end user and need not interrupt the end user unless necessary. Conversely, while in a heads down mode, the end user can continue to observe the interactions between others in the location in the virtual world and can choose to transition to a heads up mode and to participate in the location in the virtual world if the end user observes a motivating circumstance. Thus, serendipitous encounters common in the virtual world can be integrated into the productive modus operandi of the productivity application.

The process described in FIG. 1 and exemplified by the user interface in FIG. 2 can be employed in a virtual world data processing system. In illustration, FIG. 3 schematically shows a virtual world data processing system configured for deploying a virtual world within a productivity application. The system can include a host server 310 supporting the operation of a virtual server 350 generating a virtual world 330. The host server 310 can be coupled to multiple different computing devices 320 coupled to respective virtual world clients 350 over computer communications network 340. Through the virtual world clients 350, different end users can interact with the virtual world 330 via corresponding avatars in the virtual world 330.

At least one of the computing devices 320 can include a productivity application 300. The productivity application 300 can include both an editor 370 and a virtual world client 360. The productivity application 300 further can include presence awareness 380 to detect a presence of an end user interacting with the productivity application 300. Finally, the productivity application 300 can include an integrator 390. The integrator 390 can provide a presence state detected by presence awareness 380 in the productivity application 300 to the virtual world 330 viewed through the virtual world client 360.

In yet further illustration of the operation of the integrator 390 in connection with the productivity application 300, FIG. 4 is a flow chart illustrating a process for deploying a virtual world within a productivity application. Beginning in block 410, the productivity application can be loaded 410 and an end user can be logged into the virtual world 420 through a virtual world client in the productivity application. In block 430, a presence state can be detected for the end user. Thereafter, the presence state can be published to the virtual world in block 440. Subsequently, in decision block 450 if a change of presence state is detected, again the new presence can be determined in block 430 and again published to the virtual world in block 340.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A productivity application comprising:
a document editor;
a virtual world client configured to provide a view to a virtual world;
presence awareness producing a presence state for an end user of the editor; and,
an integrator configured to provide a presence state detected by the presence awareness to the virtual world viewed through the virtual world client.

2. The productivity application of claim 1, wherein the productivity application is an integrated development environment (IDE).

3. The productivity application of claim 1, wherein the virtual world provides an indication of the presence state in connection with an avatar for the end user.

4. The productivity application of claim 3, wherein the indication is a pose of the avatar in the virtual world.

5. The productivity application of claim 3, wherein the indication is text in a word bubble presented in proximity to the avatar in the virtual world.

6. A method for deploying a virtual world within a productivity application, the method comprising:
logging an end user of a productivity application into a virtual world;
detecting a presence state of the end user of the productivity application;
providing the presence state to the virtual world for reflection in connection with an avatar for the end user in the virtual world; and,
rendering a view of document editor and also a view to the virtual world in a user interface for the productivity application.

7. The method of claim 5, wherein providing the presence state to the virtual world for reflection in connection with an avatar for the end user in the virtual world, further comprises visually indicating the presence state in connection with the avatar in a word balloon displayed in proximity to the avatar in the virtual world.

8. The method of claim 5, wherein providing the presence state to the virtual world for reflection in connection with an avatar for the end user in the virtual world, further comprises visually indicating the presence state in connection with the avatar in a pose of the avatar in the virtual world.

9. A computer program product comprising a computer usable medium embodying computer usable program code for deploying a virtual world within a productivity application, the computer program product comprising:
computer usable program code for logging an end user of a productivity application into a virtual world;
computer usable program code for detecting a presence state of the end user of the productivity application;
computer usable program code for providing the presence state to the virtual world for reflection in connection with an avatar for the end user in the virtual world; and,
computer usable program code for rendering a view of document editor and also a view to the virtual world in a user interface for the productivity application.

10. The computer program product of claim 8, wherein the computer usable program code for providing the presence state to the virtual world for reflection in connection with an avatar for the end user in the virtual world, further comprises computer usable program code for visually indicating the presence state in connection with the avatar in a word balloon displayed in proximity to the avatar in the virtual world.

11. The computer program product of claim 8, wherein the computer usable program code for providing the presence state to the virtual world for reflection in connection with an avatar for the end user in the virtual world, further comprises computer usable program code for visually indicating the presence state in connection with the avatar in a pose of the avatar in the virtual world.
